(19) United States
(12) Patent Application Publication
(10) Pub. No.: US 2008/0296496 A1
(43) Pub. Date: Dec. 4, 2008

(54) METHOD AND APPARATUS OF WAFER SURFACE POTENTIAL REGULATION

(75) Inventors: Yan ZHAO, Cupertino, CA (US); Joe Wang, Sunnyvale, CA (US); Chi-Hua Tseng, Jubei City (TW)

Correspondence Address: SAWYER LAW GROUP LLP, 2465 E. Bayshore Road, Suite No. 406, PALO ALTO, CA, 94303, US

(73) Assignee: Hermes Microvision, Inc. (TAIWAN), Hsin-chu (TW)

(21) Appl. No.: 11/755,718

(22) Filed: May 30, 2007

(51) Int. Cl. G01N 23/225

(52) U.S. Cl. 250/307; 250/310; 250/306

(57) ABSTRACT

An electron beam apparatus and method are presented for regulating wafer surface potential during e-beam (scanning electron microscopy SEM) inspection and review. Regulating surface potential is often critical to detect voltage contrast (VC) defects of specific type, and sometimes, its also an important factor to achieve high quality SEM images.

### FIELD OF THE INVENTION

The present invention relates to the detection of defects in patterned substrates by inspection using scanning electron microscopy (SEM) during a semiconductor device manufacturing process. More particularly, the present invention relates to improving the uniformity and contrast of an image produces by an SEM inspection tool.

### BACKGROUND OF THE INVENTION

An electron beam apparatus and method is presented for regulating wafer surface potential during e-beam (scanning electron microscopy SEM) inspection and review. Regulating surface potential is often critical to detect voltage contrast (VC) defects of a specific type, and sometimes, it also an important factor to achieve high quality SEM images.

Integrated circuits are very complex devices that include multiple layers. Each layer may include conductive material, isolating material and semiconductor materials. Various inspection and failure analysis techniques evolved for inspecting integrated circuits both during the fabrication stages, between consecutive manufacturing stages, either in combination with the manufacturing process or not combination with the manufacturing process.

Manufacturing failures may affect the electrical characteristics of the integrated circuits. Some of these failures result from unwanted disconnections between various elements of the integrated circuits. An under-etched via or conductor can be floating instead of being connected to a conducting sub-surface structure. Such a failure can be detected due to charging differences between defective structure and non-defective structures. In order to facilitate voltage contrast analysis there must be a charging difference between the defective structure and its surroundings.

In SEM practice, after the primary beam reach and interact with specimen surface, electrons and other form of energy (signals) will emit from specimen surface. The electrons emit from specimen surface are backscattered electrons and secondary electrons. FIG. 2 illustrates the relationship between total electrons emission and primary beam energy. The emitted electrons behavior, is discussed in the “Scanning Electron Microscopy and X-Ray Microanalysis” by J. Goldstein, et al. Backscattering shows a stronger variability with energy at low beam energy, but the change is usually within a factor of 2 of high-energy values. The total emission represented by the backscattering electron coefficient (η) and the secondary electron coefficient (δ), most of the time (η+δ) is less than unity. The change in total electrons emission (BSE and SE) at low incident-beam energy really reflects the behavior of δ at low beam energy. Stating with δ=0.1, with a beam energy of 10 keV or higher, δ begins to increase significantly as the beam energy is reduced below approximately 5 keV. This variation can be understood in terms of the range of the beam electrons. The escape depth of secondary electrons is on the order of a few nanometers and majority (>90%) of the secondary electrons created at depths greater than a few nanometers are lost. When the primary beam energy is reduced below 3 keV, the primary beam range becomes so shallow that a much grater fraction of the production of secondary electrons occurs within the shallow escape depth, and δ increases. As δ increases, there comes a point E2 and, called the upper (or second) crossover point, where η+δ reach a value of unity. As the beam energy is lower further, η+δ increases above unity; that is, more electrons are emitted from the surface as results of backscattering and secondary emission than are supplied by the beam. As the beam energy is further reduced, the value of η+δ decreases until the lower (or first) crossover point E1 is reached. Below E1, η+δ decreases with decreasing beam energy. As the above discussion, by selecting the primary beam energy, the substrate surface can be positively charged (E1<E<E2) or negatively charged (E<E1 or E2<E).

FIG. 4, as an example, illustrate different effects of positive surface charge on NMOS and PMOS transistors. If the PMOS is irradiated with an electron beam of energy between E1 and E2, there is a positive voltage accumulation on the PMOS surface. The positive surface charge voltage (>0.7V) is induced to switch on the associated pn-junction; excessive charges on normal contacts will be released to the N-well. As a consequence, the positive voltage is immediately neutralized, and the poly-silicon plug is not electrically charged. Therefore, the generated secondary electrons are all emitted. On the contrary, the under-etched contact has high resistance and few electrons are supplied from the N-Well, the poly-silicon plug is positively charged. The positive voltage pulls back the generated secondary electrons and decreases the number of which emitted. As a consequence, the voltage contrast image signal is large in the normal contact portion and small in the under-etched contact portion. However, when NMOS is irradiated with an electron beam of energy between E1 and E2, a positive surface charging switches off the pn-junction. As a consequence, the voltage contrast image signal is no significant different between the normal contact portion and the under-etched contact portion.

To overcome the energy barrier over the positively charged or negatively charged substrate surface and to have better voltage contrast image, an energy filter (energy analyzer) is introduced to the system. More information on energy filter, please refer to L. Reimer, “Scanning Electron Microscopy,” Springer-Verlag Berlin Heidelberg, 1998. An example of an energy filter is a structure that metal grid electrodes are installed in front and above the substrate surface. A voltage is applied to the grid electrode, and the voltage is varied either can be positive or negative. This varies enhance or suppress the probability of secondary electrons or backscattering electrons passing through the grid electrodes.

U.S. Pat. No. 6,586,736 of McCord, U.S. Pat. No. 6,627,884 of McCord, et al., U.S. Pat. No. 6,828,571 of McCord, et al., all of which are incorporated by reference as if fully set forth herein, conditioning the substrate surface with flood gun and control the surface charge with charge control plate. U.S. Pat. No. 7,176,468 of Bertshe, et al., which is incorporated by reference as if fully set herein, varies landing energy of the electron beam of flood gun to alter the substrate surface charging condition.

U.S. Pat. No. 4,843,330 of Golladay et al., U.S. Pat. No. 6,646,242 of Todokoro et al., U.S. Pat. No. 6,853,204 of Nishyama et al., U.S. Pat. No. 7,019,292 of Fan et al., U.S. Pat. No. 7,019,294 of Koyama et al., all of which are incorporated by reference as if fully set forth herein, utilize energy filter in their system to improve voltage contrast.

During the wafer inspection practice, there may have some isolated area where the electron range of the incident beam is greater than the thickness of the insulating layer. When R(E)>t, free movable carriers are generated through the whole layer and a potential difference between the surface and the substrate will result in an electron-beam-induced current (EBIC). The rapid increase of the discharging EBIC reflects the surface potential from the strong negative surface potential suddenly drops to a small positive value. Thus, sometimes induces damage on the substrate during inspection.

Accordingly, a method and system to provide a quality voltage contrast image and to avoid electron beam induced damage during inspection, is needed. The present invention addresses such issues.

### SUMMARY OF THE PRESENT INVENTION

An electron beam apparatus and method is presented for regulating wafer surface potential during e-beam (scanning electron microscopy SEM) inspection and review. Regulating surface potential is often critical to detect voltage contrast (VC) defects of a specific type, and sometimes, it also an important factor to achieve high quality SEM images.

An object of the present invention is to provide an apparatus and method to conditioning the specimen surface according to the inspection object prior the inspection process thereafter presenting a quality image of a high resolution and low landing energy SEM.

This and other objects are achieved by setting up a wafer surface positive charge electron source in the inspection system with an incident angle varies between 0 and 90 degrees and the normal line. The angle is chosen according to the material thickness on the substrate surface and the electron range of the electron source.

In one embodiment, an apparatus for supply specimen surface voltage bias is disclosed. The apparatus includes a grid electrode over the substrate surface and a positive or a negative bias voltage is applied to the grid electrode and functions as an energy filter to enhance or to suppress electrons emitted from the substrate surface during image observation.

A system and method in accordance with the present invention makes possible various observations, inspections and measurements that heretofore could not be performed, based on the surface potential condition construct through inclined incident beam source.

This invention makes possible various observations, inspections and measurements that heretofore could not be performed, based on the surface potential condition construct through inclined incident beam source.

### BRIEF DESCRIPTION OF THE DRAWING

FIG. 1 is a diagrammatic representation of the electron beam system integrates with wafer surface potential regulation unit.

FIG. 2 is a diagrammatic representation of total electron emission from specimen surface with respect to the primary beam energy.

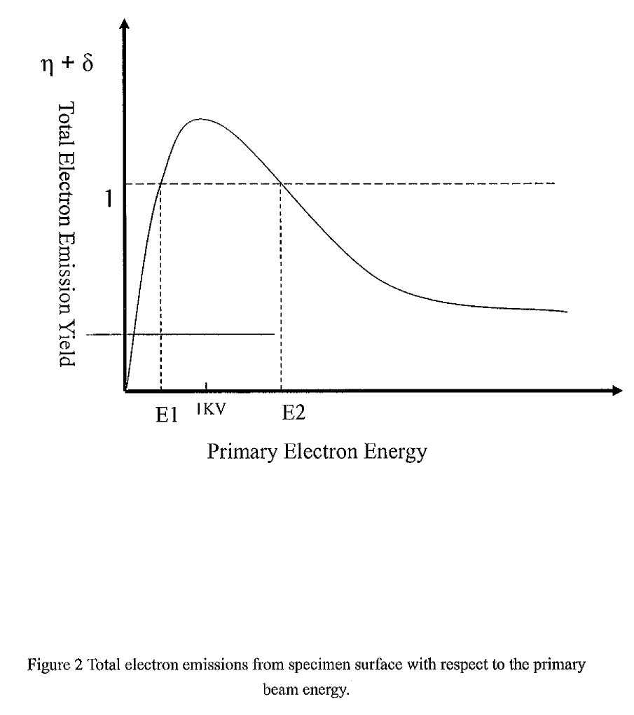

FIG. 3 is the range and generation of electron signals in a typical specimen.

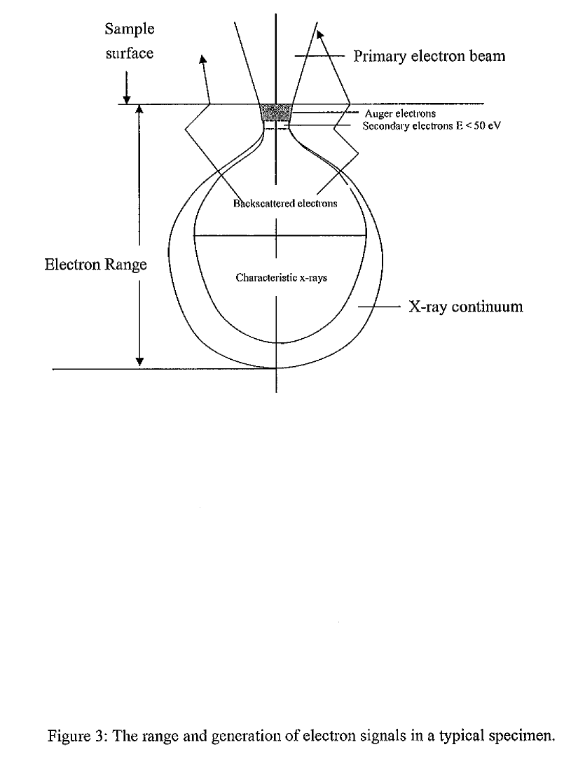

FIG. 4 illustrates the positive surface charge mode for identifying an open contact to N+ on PMOS.

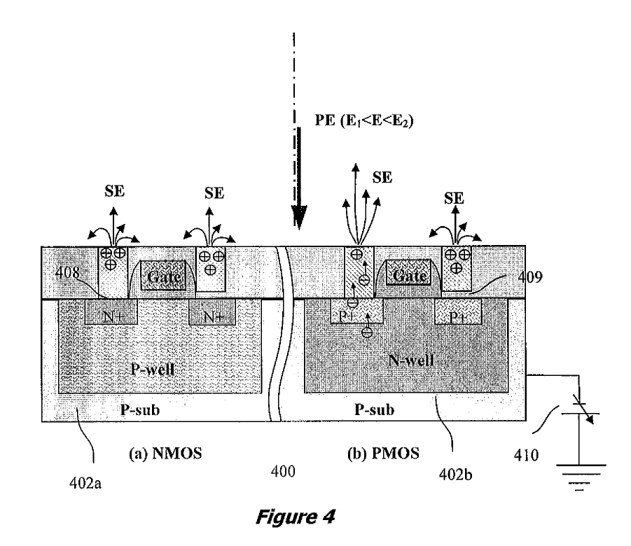

FIG. 5 is a diagrammatic representation of the wafer surface potential regulation unit.

FIG. 6 is the Monte Carlo simulation of the total electrons emission from silicon substrate surface with respect to the energy of primary beam and incident tilt angle.

FIG. 7 is the Monte Carlo simulation of the total electrons emission from silicon oxide substrate surface with respect to the energy of primary beam and incident tilt angle.

FIG. 8 is the Monte Carlo simulation of the total electrons emission from PMMA (Polymethyl Methacrylate) substrate surface with respect to the energy of primary beam and incident tilt angle.

FIG. 9 is the flow diagram for optimize voltage contrast image

FIG. 10 is the flow diagram for an inspection process that consistent with present invention.

FIG. 11 is a diagrammatic representation of inspection sequences, 11a, conditioning large area FOV then acquire images within the FOV; 11b, by turns conditioning FOV and acquiring image of the FOV.

### DESCRIPTION OF THE PREFERRED EMBODIMENTS

Reference will now be made in detail to specific embodiments of the invention. Examples of these embodiments are illustrated in accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a through understanding of the present invention. The present invention may be practiced without some or all of these specific details. In other instances, well known process operations have not been described in detail in order not to unnecessarily obscure the present invention.

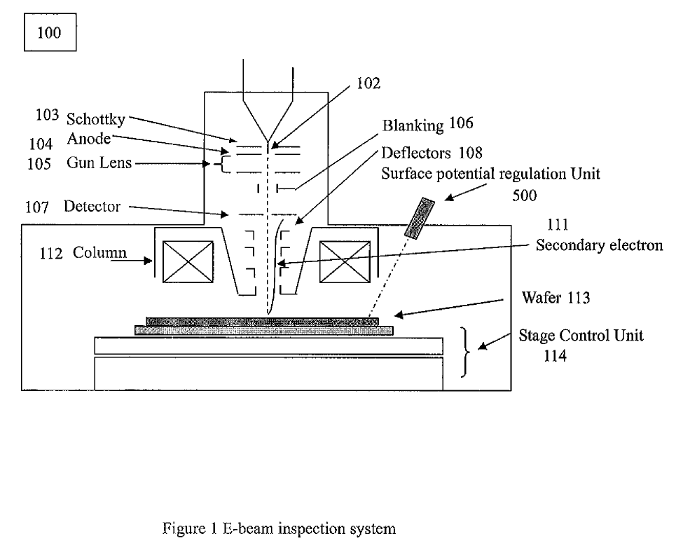

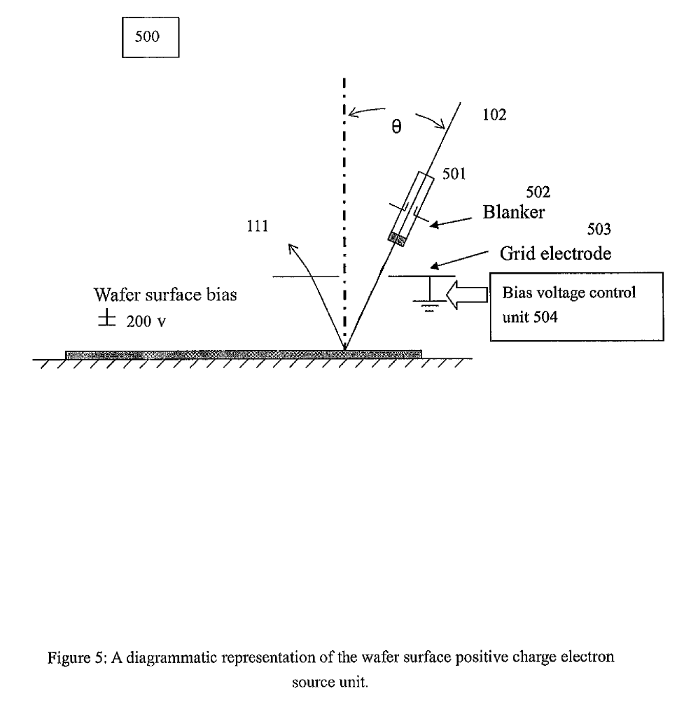

A system and method in accordance with the present invention may be implemented within any suitable measurement device that directs charged particles towards a sample and then detects emitted particles from the sample. FIG. 1 is a diagrammatic representation of an electron beam apparatus 100 (SEM) in accordance with one embodiment of the present invention. The SEM system 100 includes an electron source (101 through 112) that generates and directs an electron beam 102 substantially toward an area of interest on a specimen 113 which sits on an e-chuck mounted X-Y stage control unit 114. The electron source includes a column 112 that includes a magnetic core therewith for directing the beam. The SEM system 100 also includes an in-lens sectional detector 107 arranged to detect charged particles 111 (secondary electrons SE and/or backscattered electrons BSE) emanating from the specimen surface 113. The SEM also includes an image generator (not shown) for forming an image from the emanated particles. The surface potential regulation unit 500 with ability to vary incident angle θ to the surface normal line is mounted on the SEM system. FIG. 5 diagrammatically introduces the apparatus of the surface potential regulation unit (SPRU). The surface potential regulation unit 500 contains an electron beam source 501 and a grid electrode over the pointed area of the specimen surface 503 where a bias voltage can be applied to extract or suppress generated secondary electrons and backscattered electrons, and bias voltage control circuit 504.

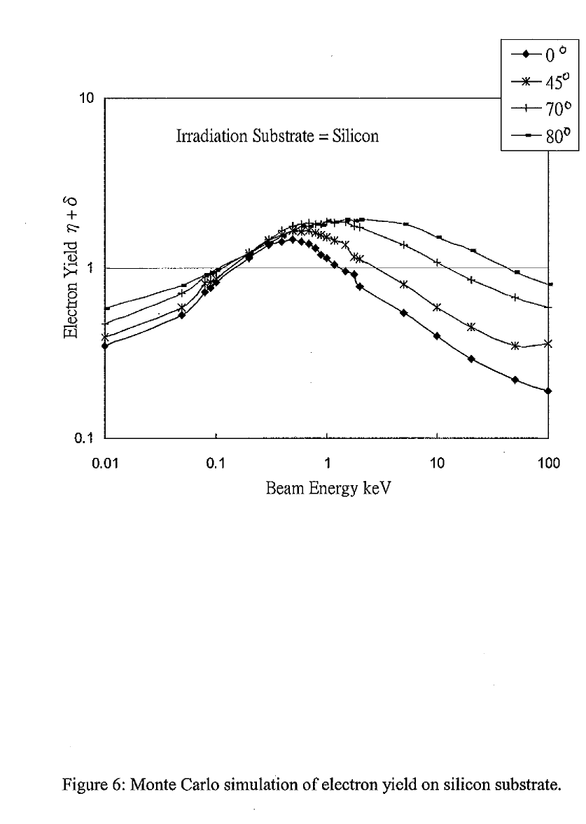

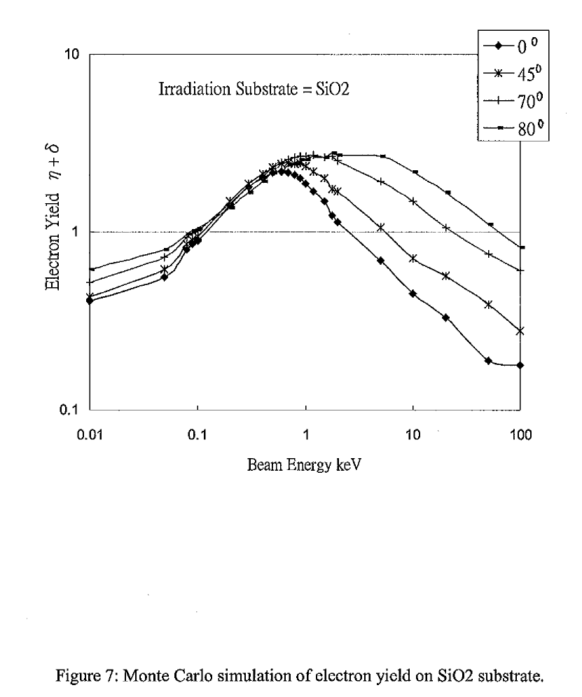

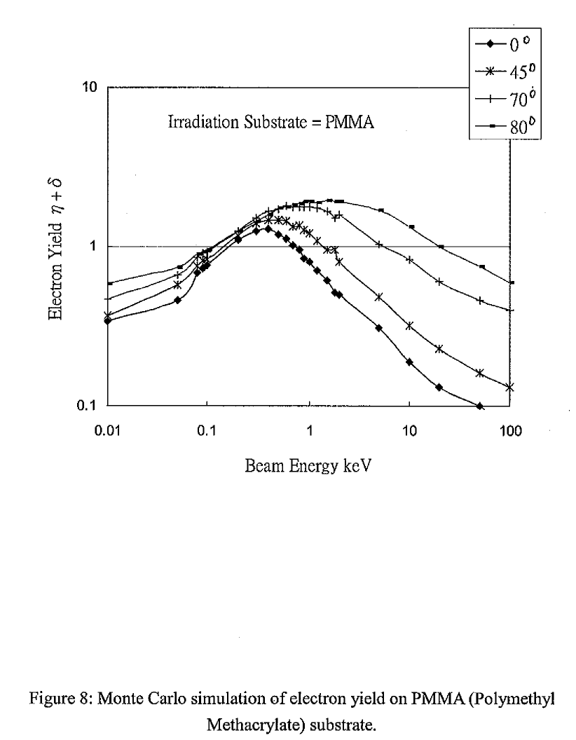

FIGS. 6, 7 and 8 plots total electron yield from the substrate surface vs. incident beam energy. The data comes from the results of a Monte Carlo simulation for typical materials used in semiconductor industry such as silicon, silicon oxide, and PMMA (Polymethyl Methacrylate) substrate respectively. For a single material, the energy range where total yield greater than 1 (E2−E1) increases as the incident beam tilt angle increases. These implies that surface positive charge can be achieved with less electron dose, if the beam incidence with a tilted angle.

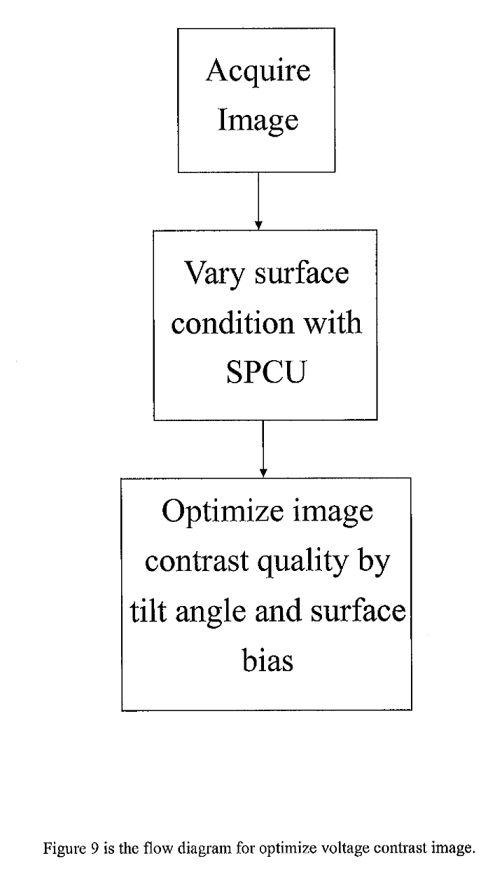

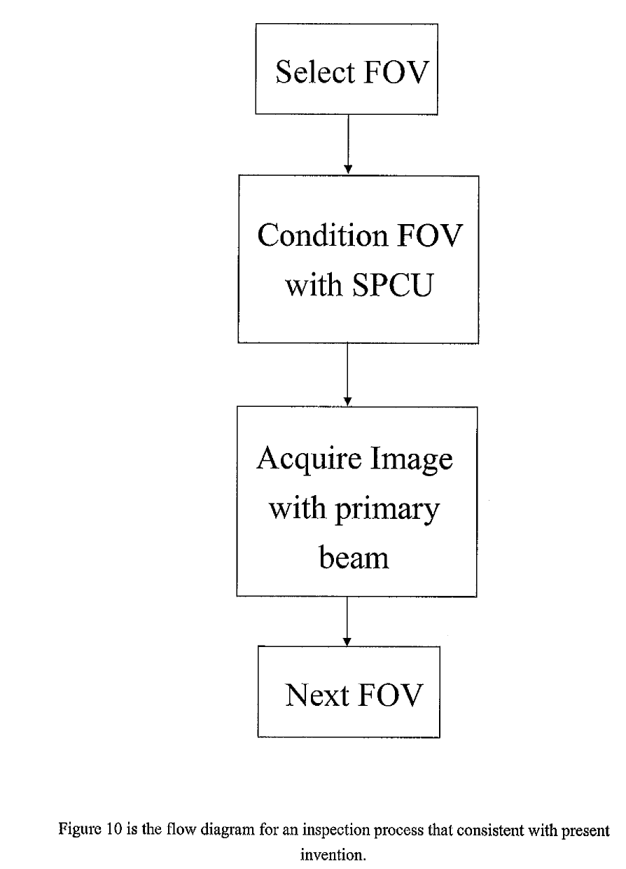

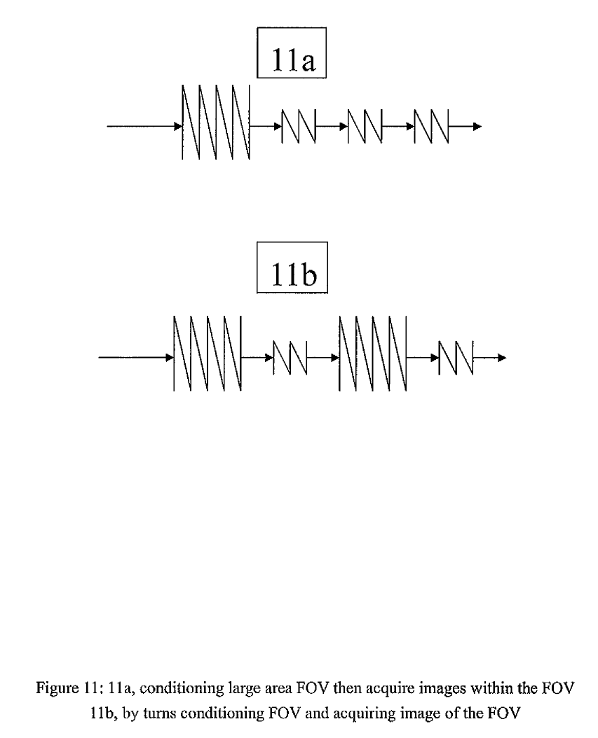

During inspection practice, first step is optimize image quality through alter the surface charging condition of the selected field of view (FOV), FIG. 9. The best image quality is set by comparing image quality of different incident beam angle and different bias voltage set on the surface positive charge unit. The second step is to irradiate the FOV with the set condition of the surface potential regulation unit. The third step is to acquire image of the FOV with the primary electron beam. FIG. 10 gives the flow diagram of inspection sequence. Once the condition is set, the inspection can perform as FIG. 11a, conditioning a large area FOV with the surface potential regulation unit then acquire image with primary beam for several small area FOV within the first FOV. Or as FIG. 11b, by turns conditioning the FOV with the surface potential regulation unit then acquire image with primary beam for the same FOV.

Another suggested inspection method is described for tools have ability to vary primary beam's incident angle. In this method, surface conditioning of the FOV with primary beam irradiate the surface with the selected tilt angle, and surface bias voltage is performed. Then the image within the FOV is acquired with primary beam from a tilted angle as depicted in FIGS. 11a and 11b.

What is claimed is:

1. An apparatus comprising:
an electron beam source to generate a primary beam; and to direct the primary beam to a selected area;
a wafer surface potential regulation unit to provide a secondary electron beam to the selected area;
a stage to hold the substrate; and
circuitry to control the bias voltage that is applied to the stage and above the specimen surface to maintain a positive potential condition during inspection.

2. The apparatus of claim 1, wherein the specimen comprises a semiconductor wafer.

3. The apparatus of claim 1, wherein the apparatus comprise an e-beam inspection tool.

4. The apparatus of claim 1, wherein the wafer surface potential regulation unit irradiates the specimen surface to alter surface potential condition with a tilted electron beam incident angle.

5. The apparatus of claim 4, wherein the incident angle may be adjusted from 0 to 80 degree respect to the normal direction of specimen surface depends the substrates material characteristics and beam energy.

6. The apparatus of claim 1, wherein the circuitry comprises a bias voltage control circuit and a grid electrode coupled to the bias voltage control circuit.

7. An image acquiring method comprising:
loading the specimen onto stage;
acquiring initial voltage contrast image of the selected area with a primary beam source;
determining the incident angle and beam energy of a surface potential regulation unit according to the material characteristics of the selected area;
irradiating the selected area with the surface potential regulation unit to adjust the surface potential condition of the selected area; and
varying the image contrast condition through adjusting bias voltage applied to the grid electrode over specimen surface; and
acquiring a voltage contrast image of the selected area afterconditioning with primary beam source.

8. An apparatus comprising:
an electron beam source to generate the primary beam; and to direct the primary beam to the selected area, wherein the primary beam can be tilted to allow for acquiring an image utilizing the source;
a stage to hold the substrate; and
circuitry to control the bias voltage that is applied to the stage and above specimen surface to maintain the positive potential condition during inspection.

9. The apparatus of claim 8, wherein the specimen comprises a semiconductor wafer.

10. The apparatus of claim 8, wherein the apparatus comprise an e-beam inspection tool.

11. The apparatus of claim 8, wherein the electron beam source comprises acts as the wafer surface potential regulation unit, irradiates the specimen surface to alter surface potential condition with a tilted electron beam incident angle.

12. The apparatus of claim 11, wherein the incident angle may be adjusted from 0 to 80 degree respect to the normal direction of specimen surface depends the substrates material characteristics and beam energy.

13. The apparatus of claim 8, wherein the circuitry comprises a bias voltage control circuit and a grid electrode coupled to the bias voltage control circuit.

14. An image acquiring method comprising:
loading the specimen onto a stage;
acquiring initial voltage contrast image of the selected area with primary beam source (normal angle);
determining the incident angle and beam energy for surface positive potential condition according to the material characteristics of the selected area;
irradiating the selected area with the primary beam with the retarded landing energy and tilt angle to adjust the surface potential condition of the selected area;
varying the image contrast condition through adjusting bias voltage applied to the grid electrode over specimen surface; and
acquiring voltage contrast image of the selected area after conditioning with primary beam source (normal angle).
